(19) United States
(12) Patent Application Publication
(10) Pub. No.: US 2026/0161912 A1
(43) Pub. Date: Jun. 11, 2026

(54) LASER MARKING OF OBJECTS

(71) Applicant: KRONES AG, Neutraubling (DE)

(72) Inventors: Ute WINTER, Wenzenbach (DE); Andreas KRAUS, Lappersdorf (DE)

(21) Appl. No.: 19/408,998

(22) Filed: Dec. 4, 2025

(30) Foreign Application Priority Data
Dec. 5, 2024 (DE) 102024136397.5

(51) Int. Cl. G06K 15/02; B41J 2/455; B41J 3/01; B41J 3/407

(52) U.S. Cl. CPC G06K 15/1836; B41J 2/455; B41J 3/4073; G06K 15/1868; B41J 3/01

(57) ABSTRACT

The invention relates to, inter alia, a method for laser marking of objects (12), preferably containers. The method includes: providing a representation (D) of a desired laser marking; applying a computer-assisted procedure to the representation (D) which divides the representation (D) into a plurality of sub-regions (T1-T5); and laser marking the plurality of sub-regions (T1-T5) on an object (12) by a plurality of laser marking apparatuses (20) to generate the representation (D) on the object (12), wherein the plurality of laser marking apparatuses (20) each laser mark one of the plurality of sub-regions (T1-T5) on the object (12).

### CROSS-REFERENCE TO RELATED APPLICATIONS

This application claims priority to DE 10 2024 136 397.5 filed Dec. 5, 2024, the contents of which are incorporated herein by reference in their entireties.

### TECHNICAL FIELD

The invention relates to methods for laser marking of objects and to a system for laser marking of objects.

### TECHNICAL BACKGROUND

Standardly, the majority of containers are fitted with labels. Typical variants are paper or plastics material labels, which are processed with hot or cold glue or are self-adhesive and applied to the containers.

Labels can be problematic in the recycling process, e.g., due to the printing ink used, waterproof paper, glue, etc. In the context of increasing global sustainability discussions, various features inherent to the technology here may be considered disadvantageous. These can include, in particular, the use of plastics materials for container decoration, a poor CO2 footprint in label production (especially plastics materials), through logistics, to application (especially shrink sleeves) and limited recyclability in the usual waste streams. Analogous points can also be mentioned in the direct printing processes.

In principle, it is therefore desirable to dispense with labels completely. Required information could, for example, be marked or written directly on the containers using a laser marking system. This technology is already used, for example, to laser mark a production number or a “best used before” date. During laser marking, the laser beam and the heat it generates on the surface of the container can cause a physical change to the surface of the container (e.g., whitening of PET containers) so that the desired characters can be laser-marked on the surface.

For example, GB 2576220 A discloses a laser marking apparatus for marking containers.

The lasers currently used are limited in power. In combination with the requirements of, for example, high-performance filling systems, it is therefore conceivable to use a plurality of lasers. However, the use of multiple lasers presents certain difficulties, which are discussed herein.

The invention is based on the object of creating an improved technology for laser marking of objects, preferably containers. The technology is primarily used in the high-performance range and still allows the creation of visually appealing laser markings on the objects.

### SUMMARY OF THE INVENTION

The object is achieved by the invention.

One aspect relates to a method for laser marking (e.g., by a system as disclosed herein) of objects, preferably containers. The method comprises the following:
providing a (e.g., two-dimensional) representation (e.g., as an image file) of a desired laser marking (e.g., in a memory of a processing device);
applying a computer-assisted procedure, preferably an algorithm (e.g., calculation algorithm; e.g., in the sense of an instruction for action) to the representation (e.g., by a processing device), which divides the representation into a plurality of sub-regions (e.g., as image files); and
laser marking the plurality of sub-regions on an object by a plurality of laser marking apparatuses to generate the representation on the object, wherein the plurality of laser marking apparatuses each laser mark (only) one of the plurality of sub-regions on the object.

The proposed method allows a representation to be laser marked to be automatically divided into sub-regions according to predetermined criteria and boundary conditions, which are then laser marked on the object by different laser marking apparatuses one after the other, with temporal overlap or simultaneously. The use of the procedure allows the sub-regions to be formed not on the basis of manual, subjective decisions, but in a comprehensible, repeatable and optimized manner by a processing device. This allows the representation to be intelligently separated/divided into sub-regions. The procedure can lead to the most optimal solution possible for the division of the sub-regions, in which, for example, an optimized marking time for each sub-region, substantially the same marking times for all laser marking apparatuses and a graphic creation of appropriate and visually appealing separation points/separation zones between the sub-regions can be achieved. As a result, the laser technology used can be optimally utilized, as approximately equal marking times are made possible for each laser marking apparatus. In addition, visually imperceptible/conspicuous seams between the sub-regions can be achieved by clever division and subsequent stitching during the final laser marking. This allows for laser marking that remains visually appealing and, for example, legible, even in the event of tolerance-related positioning inaccuracies of the laser marking apparatuses. This can result in system simplification, since system tolerances resulting from substrate movement/positioning are less visually noticeable, or the system can be made with larger tolerances.

In one exemplary embodiment, at least one of the following is fulfilled:
the multiple sub-regions do not overlap one another or the procedure divides the representation in such a way that the multiple sub-regions do not overlap one another;
the multiple sub-regions are adjacent to one another or the procedure divides the representation in such a way that the multiple sub-regions are adjacent to one another;
the plurality of sub-regions together form the representation (e.g., placed next to one another (e.g., in vector graphics) or superimposed (e.g., in raster graphics)) or the procedure divides the representation in such a way that the plurality of sub-regions together form the representation;
the multiple sub-regions have a substantially equal number of characters; and
the multiple sub-regions have substantially the same processing time (e.g., sum of marking time and jump time);
a dividing line between the plurality of sub-regions has a plurality of line portions that are at an angle to one another and are preferably straight.

In a further exemplary embodiment, at least one of the following conditions is met:
the plurality of sub-regions are formed to reduce (e.g., minimize or prevent) representation elements (e.g., line, character) that cross sub-regions (or the procedure divides the representation such that the plurality of sub-regions are formed to reduce representation elements that cross sub-regions); and
the plurality of sub-regions are formed to optically reduce tolerance-related positioning inaccuracies at transitions between the plurality of sub-regions during laser marking of the plurality of sub-regions (or the procedure divides the representation in such a way that the plurality of sub-regions and transitions between the plurality of sub-regions are formed to optically reduce tolerance-related positioning inaccuracies during laser marking of the sub-regions).

This can advantageously improve the overall optical impression of the laser marking even in the case of tolerance-related inaccuracies, and larger tolerances can thus for example be accepted overall, which can allow for example system simplification and/or increased performance.

Preferably, the plurality of sub-regions can be formed to reduce subregion-relevant deviations from a focus (e.g., of the plurality of laser marking apparatuses).

In one embodiment, applying the procedure comprises:
detecting (recognizing) one or more potential separation zones (e.g., in point form or in line form) in the representation which satisfy at least one predetermined separation criterion of the procedure, wherein the procedure divides the representation into the plurality of sub-regions depending on the at least one detected (recognized) potential separation zone, preferably in such a way that the representation is divided at at least one of the detected (recognized) potential separation zones (e.g., into two or more sub-regions).

Advantageously, the separation zones or seams between the sub-regions can thus be formed in such a way that the overall optical impression of the laser marking can be improved even in the case of tolerance-related inaccuracies, with the additional advantages already explained.

In a further exemplary embodiment, the at least one predetermined separation criterion has at least one of the following:
an empty zone separation criterion that is met when there is a zone of the representation that is free of elements of the representation;
a discontinuity separation criterion that is met when there is a discontinuous, preferably angled, line transition in the representation;
a density separation criterion that is met if a zone of the representation has a lower point density and/or a lower line density relative to other zones of the representation and/or has an absolute point density and/or line density which is smaller than a predetermined limit value;
a syntax separation criterion that is met when there is a space between strings of contiguous characters;
a character number separation criterion that is met between regions of the representation each having a substantially equal number of characters; and
a processing time synchronization separation criterion that is met between regions of the representation each having a substantially equal processing time (e.g., sum of marking time and jump time).

In this context, it is also conceivable that a predetermined preprocessing of the representation is carried out, in which potential separation zones can be deliberately created in the representation.

In one embodiment variant, applying the procedure comprises:
detecting (recognizing) one or more connection zones in the representation which satisfy at least one predetermined connection criterion of the procedure, wherein the procedure divides the representation into the plurality of sub-regions depending on the at least one detected (recognized) connection zone, preferably in such a way that the representation is not divided in at least one of the detected (recognized) connection zones.

Advantageously, the sub-regions can thus be formed in such a way that no or hardly any visually unattractive separation points of the laser marking occur when there are tolerance-related inaccuracies, with the further advantages already explained.

In a further embodiment variant, the at least one predetermined connection criterion has at least one of the following:
a fill zone connection criterion that is met when there is a zone of the representation that is filled with representation elements;
a continuity connection criterion that is met when there is a continuous line transition in the representation;
a density connection criterion that is met if a zone of the representation has a higher point density and/or a higher line density relative to other zones of the representation and/or has an absolute point density and/or line density that is greater than a predetermined limit value; and
a syntax connection criterion that is met when there is a string of contiguous characters;
a code connection criterion that is met when there is a visual code (e.g., QR code, barcode, Aztec code, Data Matrix, PDF417, AR code, etc.) made up of contiguous code elements;
a processing time connection criterion that is met if a division into sub-regions is unnecessary due to a total processing time that is below a limit value (i.e., is sufficient).

It is possible that a plurality of predetermined separation point criteria and/or a plurality of predetermined connection criteria are included in the procedure, which preferably:
are or can be at least differently weighted at least in part; and/or
are taken into account in a predetermined order in the procedure; and/or
can be selectively chosen when applying the procedure (e.g., via a user interface).

In one exemplary embodiment, at least one of the following is fulfilled:
the procedure divides the representation into the plurality of sub-regions depending on a predetermined maximum marking speed (maximum writing speed) of the plurality of laser marking apparatuses and/or a predetermined maximum jump speed of the plurality of laser marking apparatuses; and
the procedure divides the representation into the plurality of sub-regions such that marking durations of the plurality of laser marking apparatuses for laser marking the corresponding sub-region are substantially equal.

As a result, the laser technology used can be optimally utilized, as approximately equal marking times are made possible for each laser marking apparatus.

In another exemplary embodiment, the method further comprises the following:
conveying the object using a (e.g., rotary) object conveyor (e.g., container conveyor) during the laser marking.

Preferably, the procedure can divide the representation into the plurality of sub-regions depending on a, preferably predetermined or predeterminable, conveying speed of the object conveyor; and/or on a (e.g., predetermined) object distance between adjacent objects conveyed by the object conveyor; and/or on an overall movement profile (e.g., propulsion movement and/or rotation about each object's own vertical axis) of the objects during conveying.

In this way, a configuration can be found that allows for optimal interaction with the object conveyor.

In one embodiment, the procedure estimates (approximately ascertains) a total marking duration of the representation depending on a maximum marking speed of the plurality of laser marking apparatuses. Optionally, a maximum jump speed of the plurality of laser marking apparatuses and/or a conveying speed of an object conveyor and/or a target output power (desired output power) of the plurality of laser marking apparatuses can be taken into account during the estimation. The estimated total marking duration can for example be divided by the number of the plurality of laser marking apparatuses to calculate an individual marking duration. Preferably, the multiple sub-regions can be formed depending on the calculated individual marking duration.

This advantageously makes it possible to achieve approximately equal marking times for each laser marking apparatus.

In a further embodiment, the procedure can calculate and output (e.g., via a user interface) a required number of the plurality of laser marking apparatuses for laser marking the plurality of sub-regions depending on the representation (e.g., size, shape, content, number of representation elements, point density and/or line density) and a maximum marking speed of the plurality of laser marking apparatuses (and optionally a maximum jump speed of the plurality of laser marking apparatuses) and optionally an object conveying speed of an object conveyor and/or a (e.g., predetermined or predeterminable) individual marking duration for the plurality of laser marking apparatuses.

This technique can be used advantageously, for example, when initially assembling the entire system or when, for example, it is desired that a representation is laser-marked with a minimum number of laser marking apparatuses and any remaining laser marking apparatuses remain in reserve or are temporarily spared.

In one embodiment variant, the representation is a raster graphic. The procedure can divide the raster graphic into the plurality of sub-regions in such a way that the plurality of sub-regions are each formed by a plurality of representation points of the raster graphic, which are distributed over the entire raster graphic and differ from the plurality of representation points of the other sub-regions. Preferably, the raster graphic can then be created by (e.g., flush) superimposition of the plurality of sub-regions.

In one embodiment variant, the representation is a vector graphic or a raster graphic. The procedure can divide the vector graphic or raster graphic into the plurality of sub-regions in such a way that the plurality of sub-regions each extend only over a part of the vector graphic or raster graphic and/or are each substantially formed by representation elements contiguous with one another of the vector graphic or raster graphic. Preferably, placing the plurality of sub-regions side by side can then result in the vector graphic or raster graphic.

In one exemplary embodiment, the procedure is an AI procedure. Preferably, the AI procedure can be trained by inputting representations and associated divided sub-regions. Alternatively or additionally, the AI procedure can be trained on the object by inputting the or a (further) representation, the associated divided (further) sub-regions and a result of the laser marking of the plurality of (further) sub-regions recorded by a preferably camera-supported sensor apparatus. This can advantageously reduce the programming effort for the procedure and a self-learning procedure can be created.

Another aspect relates to a system for laser marking of objects (e.g., containers). The system comprises a processing device configured to apply a computer-assisted procedure (e.g., as disclosed herein), preferably an algorithm, to a provided (e.g., two-dimensional) representation (e.g., image file) that divides the representation into a plurality of sub-regions. The system further comprises a plurality of laser marking apparatuses configured to receive the plurality of sub-regions divided by the processing device and to laser mark them on the object to generate the representation on the object, wherein the plurality of laser marking apparatuses each laser mark and preferably receive (only) one of the plurality of sub-regions on the object. Optionally, the system can further comprise an (e.g., rotary) object conveyor (e.g., container conveyor) arranged to convey the objects along the plurality of laser marking apparatuses.

Advantageously, with the system the same advantages can be achieved as already explained with reference to the method.

It is understood that all features described with reference to the method are also disclosed and claimable in relation to the system, and vice versa.

A further aspect of the present disclosure relates to a container processing plant (e.g., for controlling the temperature, producing, cleaning, coating, testing, filling, closing, pasteurizing, decorating, labeling, printing, marking, laser marking, and/or packaging containers for liquid or pasty media, preferably beverages, liquid foods or products from the pharmaceutical or healthcare industry). The container processing plant can comprise the system as disclosed herein. The container processing plant can, for example, be a beverage filling plant.

For example, the containers can be realized as bottles, cans, canisters, cartons, vials, tubes, etc.

Preferably, the term “control device” and/or “processing apparatus” can refer to an electronic system (for example, configured as a driver circuit or with microprocessor(s) and data memory) which, depending on the realization, can perform control tasks and/or regulation tasks and/or processing tasks. Although the term “control” is used herein, this can also comprise or be understood as “closed-loop control” or “control with feedback” and/or “processing” as appropriate. The processing apparatus can, for example, be a central processing apparatus or can have a plurality of decentralized or distributed processing units.

Another aspect relates to a computer program product comprising (e.g., at least one computer-readable storage medium having stored thereon) instructions that cause a computing apparatus to perform a procedure as disclosed herein.

The preferred embodiments and features of the invention described above can be combined with one another as desired.

### BRIEF DESCRIPTION OF THE FIGURES

Further details and advantages of the invention are described below with reference to the accompanying drawings, in which:

FIG. 1 shows a schematic representation of a system in accordance with an exemplary embodiment;

FIG. 2 shows a flowchart of a method for laser marking objects in accordance with an exemplary embodiment;

FIG. 3 shows a division of a representation into a plurality of sub-regions;

FIG. 4 shows a division of a representation into a plurality of sub-regions;

FIG. 5 shows a division of a representation into a plurality of sub-regions;

FIG. 6 shows a division of a representation into a plurality of sub-regions;

FIG. 7 shows conceivable laser markings in the case of a tolerance-related positioning inaccuracy of the laser marking apparatuses which laser mark the plurality of sub-regions according to FIG. 6;

FIG. 8 shows a division of a representation into a plurality of sub-regions; and

FIG. 9 shows a conceivable laser marking in the case of a tolerance-related positioning inaccuracy of the laser marking apparatuses which laser mark the plurality of sub-regions according to FIG. 8.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

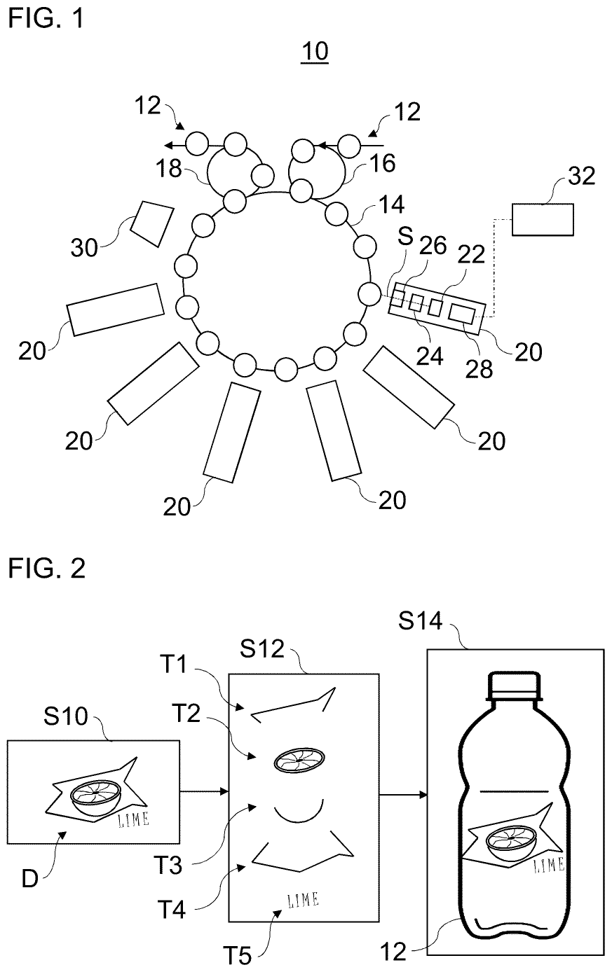

FIG. 1 shows a system 10 for laser marking of objects 12. The objects 12 are preferably embodied as containers. Preferably, the system 10 can be comprised or arranged in a container processing plant, e.g., a beverage filling plant.

The system 10 comprises a plurality of laser marking apparatuses 20 and a processing device 32. Preferably, the system 10 can further comprise an object conveyor 14 and/or a sensor apparatus 30.

The object conveyor 14 can transport the objects 12. Preferably, the object conveyor 14 is single-track. Preferably, the object conveyor 14 transports the objects 12 at a distance from one another, e.g., in individual transport.

The object conveyor 14 is preferably arranged to convey the objects 12 along the laser marking apparatuses 20. For example, the laser marking apparatuses 20 can be arranged laterally next to the object conveyor 14, e.g., inside or outside thereof.

For example, the object conveyor 14 can be a rotary object conveyor (object conveyor carousel), as shown by way of example in FIG. 1. The object conveyor 14 can transport the objects 12 on a circular path.

Alternatively, the object conveyor 14 could for example be a linear object conveyor. The linear object conveyor can, for example, have a preferably circulating conveying element for transporting the objects 12. The linear object conveyor can be, for example, a belt, strap, chain or plate conveyor. It is also possible for the linear object conveyor to be embodied as a long stator linear motor object conveyor or (magnetic) planar motor drive object conveyor which can move the objects 12 independently of one another using movement apparatuses (mover, shuttle).

The object conveyor 14 can support the objects 12 during transport, preferably on their base side and/or circumferential side and/or from above. The object conveyor 14 can have object holders for supporting the objects 12. The object holders can preferably hold the objects 12 in base handling or neck handling.

For example, the object holders can each support an object 12. The object holders can, for example, each have a container plate, a centering bell, a container clamp, and/or an inflation apparatus.

It is possible for the object conveyor 14 to be configured to rotate each of the transported objects 12 about its own vertical axis. Preferably, the object holders can be rotatable for rotating each of the objects 12 about its vertical axis.

It is also possible that the object conveyor 14 has no separate object holders, and, for example, the objects 12 are simply supported on a, preferably circulating, conveying element (e.g., band, strap, belt, chains, or plates) of the object conveyor 14.

The object conveyor 14 can be arranged downstream in the object flow from an infeed conveyor 16. The infeed conveyor 14 can be, for example, a rotary object conveyor or a linear object conveyor. The object conveyor 14 can take over the objects 12 transported by the infeed conveyor 16.

The object conveyor 14 can be arranged upstream in the object flow from an outfeed conveyor 18. The outfeed conveyor 18 can be, for example, a rotary object conveyor or a linear object conveyor. The object conveyor 14 can transfer the objects 12 (after laser marking by the laser marking apparatuses 20) to the outfeed conveyor 18.

The laser marking apparatuses 20 can be arranged along the object conveyor 14. For example, the laser marking apparatuses 20 can be arranged next to one another or one behind the other along the object conveyor 14. Other arrangements, e.g., at least partially one above the other and/or on both long sides of the object conveyor 14, are also possible. The laser marking apparatuses 20 can laser mark the objects 12 while the objects 12 are being conveyed/transported by the object conveyor 14 along the laser marking apparatuses 20.

The laser marking apparatuses 20 can also be referred to as laser labeling apparatuses, laser coding apparatuses or laser inscription apparatuses. Preferably, the laser marking apparatuses 20 can be CO2 laser marking apparatuses, fiber laser marking apparatuses or UV laser marking apparatuses.

For example, the laser marking apparatuses 20 can each have a laser source 22, a marking head 24, focusing optics 26 and/or their own control device 28 (shown in FIG. 1 only for one of the laser marking apparatuses 20, for clarity).

The laser source 22 can be embodied as a laser tube, for example. The laser tube may be sealed. The laser tube can be filled with a gas, e.g., containing CO₂, or a gas mixture, e.g., a CO₂—N₂—He gas mixture. Electrodes can also be arranged in the laser tube. A supply unit can be connected to the electrodes (not shown in FIG. 1). The supply unit can supply the laser source 22 with electrical energy. Using for example a high-frequency voltage, molecules, e.g., CO₂ molecules, can be excited to oscillate in the laser tube and thus to emit a laser beam. The laser source 22 can also be referred to as an oscillator.

The laser beam S generated by the laser source 22 can be guided or directed to the marking head 24 directly or via mirrors. It is possible for a so-called telescope for expanding the laser beam S to be arranged between the laser source 22 and the marking head 24, for example.

The marking head 24 can also be referred to as a coding head or writing head. The marking head 24 can preferably have two movable mirrors and two drives for the mirrors. The first drive can rotate the first mirror about a first axis (e.g., x-axis). The first mirror can for example also be referred to as a movable scanner mirror, e.g., an X-scanner mirror. The second drive can rotate the second mirror about a second axis (e.g., y-axis). The second mirror can for example also be referred to as a movable scanner mirror, e.g., a Y-scanner mirror. The first axis and the second axis can preferably run perpendicular to one another.

The mirrors moved by the drives can direct the laser beam S according to the laser marking to be applied. This allows the laser beam S to move across the surface of an object 12, for example while writing.

The focusing optics 26 can also be referred to as a condenser or condenser optics. The focusing optics 26 are preferably planar field focusing optics. The planar field focusing optics can specify a planar focal plane. The planar field focusing optics can, for example, be or have an F-theta lens. Before the laser beam S impinges on the surface of the object 12, it can be focused by the focusing optics 26.

The focusing optics 26 can for example be integrated with the marking head 24 or arranged separately from the marking head 24.

The control device 28 can operate the marking head 24 of the corresponding laser marking apparatus 20 to produce a laser marking on a surface of the object 12.

For example, the control device 28 can receive a sub-region of a two-dimensional representation (2D representation) of a desired laser marking, e.g., from the processing device 32. The sub-region of the two-dimensional representation can preferably be received in the form of an image file. The two-dimensional representation and the sub-region thereof can be for example vector graphics or raster graphics.

The control devices 28 of the laser marking apparatuses 20 can receive different sub-regions of the representation of the desired laser marking. Together (e.g., placed on top of one another or next to one another) the sub-regions can form the (complete) representation.

Preferably, the control device 28 can operate the drives of the marking head 24 depending on the received sub-region of the two-dimensional representation. For example, the control device 28 can generate movement commands, such as drive signals, for the drives depending on the received sub-region in order to generate the laser marking.

The sensor apparatus 30 can be arranged next to the object conveyor 14 or, for example, downstream therefrom in the object flow. With respect to a transport path of the objects 12 through the system 10, the sensor apparatus 30 is preferably arranged downstream of the laser marking apparatuses 20.

The sensor apparatus 30 can be directed toward the object conveyor 14 or toward the objects 12 transported by the object conveyor 14.

The sensor apparatus 30 can for example comprise a camera apparatus, an LED detection apparatus or a laser detection apparatus.

The sensor apparatus 30 can for example detect the laser markings on the objects 12. The detected laser markings can preferably each be captured as an image file.

The processing device 32 can be, for example, a PC or a server. Alternatively, the processing device 32 can be integrated e.g., with the control devices 28.

The processing device 32 can for example be in communication with the control devices 28 of the laser marking apparatuses 20. The processing device 32 can send sub-regions of a, preferably two-dimensional, representation to the control devices 28 for the laser marking.

The processing device 32 is configured to apply a procedure to the representation of the desired laser marking for dividing the representation into the plurality of sub-regions, as will be explained in more detail herein and with reference to examples. In principle, it is possible that the procedure is implemented at least partially in hardware and/or at least partially in software.

FIG. 2 schematically shows a method for laser marking.

In a step S10, a preferably two-dimensional representation D of a desired laser marking is provided, e.g., as an image file. Preferably, the representation D can be provided by the processing device 32. The processing device 32 can have received the representation D for example via a communication interface. It is also possible that the representation D is created by the processing device 32, e.g., by user input.

In a step S12, a computer-assisted procedure, e.g., an algorithm, is applied to the representation D. The procedure divides the representation D into a plurality of sub-regions T1-T5. The sub-regions T1-T5 are preferably provided as image files. Preferably, the processing device 32 can apply the procedure to the representation D.

It is understood that a number of the sub-regions T1-T5 may vary depending on the representation D and the available equipment, in particular laser marking apparatuses 20. Preferably, a number of the sub-regions T1-T5 can be less than or equal to a number of the laser marking apparatuses 20.

The procedure can preferably divide the representation D such that the sub-regions T1-T5 do not overlap one another. The sub-regions T1-T5 can for example be adjacent to one another. Together, the sub-regions T1-T5 can form the representation D.

If the representation D is, for example, substantially composed of characters (e.g., numbers, letters, etc.), the sub-regions T1-T5 can preferably be formed such that they have a substantially equal number of characters, e.g., with a tolerance of ±10%, ±15% or ±20%.

Particularly preferably, the procedure divides the representation D in such a way that the plurality of sub-regions T1-T5 are formed to reduce representation elements that cross sub-regions, such as lines, characters, etc. The sub-regions T1-T5 can thus contribute to the optical reduction of tolerance-related positioning inaccuracies at transitions between the plurality of sub-regions T1-T5 during laser marking of the sub-regions T1-T5.

Preferably, the procedure can identify one or more potential separation zones in the representation D that satisfy at least one predetermined separation criterion of the procedure. At one or more of the detected potential separation zones, the representation D can then be divided into the plurality of sub-regions T1-T5, e.g., depending on further parameters, such as at least one of the number of laser marking apparatuses 20, the maximum marking speed of the laser marking apparatuses 20, the object conveying speed of the object conveyor 14, etc.

For example, the procedure can use an empty zone separation criterion. The empty zone separation criterion can be met if a zone of representation D free of representation elements is present or detected. This representation element-free zone can accordingly be detected as a potential separation zone.

As another example, the procedure can use a discontinuity separation criterion. The discontinuity separation criterion can be met if a discontinuous, preferably angled, line transition (mathematical discontinuity point) is present in the representation D. This discontinuous line transition can accordingly be detected as a potential separation zone.

It is also possible that the procedure uses a density separation criterion. The density separation criterion is met if a zone of the representation D has a lower point density and/or a lower line density relative to other zones of the representation D. This zone can accordingly be detected as a potential separation zone. This criterion can be used alternatively or additionally, for example, as an absolute criterion with a limit value for the (point/line) density.

It is also possible that the procedure uses a syntax separation criterion. The syntax separation criterion can be met if there is a space between strings of contiguous characters. The zone in which the distance lies can accordingly be detected as a potential separation zone.

It is also possible that, for example, a processing time synchronization separation criterion is used. This can be met between regions of the representation with substantially the same (laser) processing time.

While the separation criteria mentioned above are aimed at finding possible boundaries or dividing lines/seams to delimit the sub-regions T1-T5 to be formed, it is alternatively or additionally possible, for example, that the procedure detects one or more connection zones in the representation D that meet at least one predetermined connection criterion of the procedure.

The detected connection zones can be zones in which a division into the sub-regions T1-T5 is not advantageous, since, for example, even in the case of small tolerance-related positioning inaccuracies during laser marking, they lead to a poor overall visual impression or significantly impair the readability of the laser-marked representation D. Accordingly, the procedure can divide the representation D into the sub-regions T1-T5 depending on the at least one detected connection zone, preferably in such a way that the representation D is not divided in at least one of the detected connection zones.

For example, the procedure can use a fill zone connection criterion. The fill zone connection criterion can be met, for example, if a zone of representation D filled with representation elements is present or detected. Representation elements can be, for example, points, lines, characters, etc. The zone filled with representation elements can accordingly be detected as a connection zone.

As another example, the procedure can use a continuity connection criterion. The continuity connection criterion can be met if a (mathematically) continuous line transition is present or detected in the representation D. This continuous line transition can be detected as a connection zone.

It is also possible that the procedure uses a density connection criterion. The density connection criterion can be met if a zone of the representation D has a higher point density and/or a higher line density relative to other zones of the representation D. This zone can accordingly be detected as a connection zone. This criterion can be used alternatively or additionally, for example, as an absolute criterion with a limit value for the (point/line) density.

It is also possible that the procedure uses a syntax connection criterion. The syntax connection criterion can be met if a string of contiguous characters is present or detected (e.g., a word or a date or a multi-digit number). This string can accordingly be detected as a connection zone.

It is also possible to use a code connection criterion, which is met when there is a visual code (e.g., QR code, barcode, Aztec code, Data Matrix, PDF417, AR code, etc.) made up of contiguous code elements.

It is also possible to use a processing time connection criterion, which is met if a division into sub-regions is unnecessary due to sufficient total processing time. The total processing time can, for example, be less than a predetermined limit value. Advantageously, separation can thus be omitted if separation is not to be done at all due to time constraints or machine performance reasons.

It is understood that the procedure preferably uses a plurality of separation point criteria and/or a plurality of connection criteria to divide the representation D into the plurality of sub-regions T1-T5, possibly depending on further parameters, as already mentioned.

If a plurality of criteria are used, these can for example be weighted differently, at least in part, can be considered in a predetermined order in the procedure, and/or can be capable of being selectively chosen when applying the procedure.

As already mentioned, the procedure can divide the representation D into the sub-regions T1-T5 depending on a predetermined maximum marking speed of the laser marking apparatuses 20. Optionally, for example, a predetermined maximum jump speed of the laser marking apparatuses 20 can be taken into account. This/these parameter(s) can be used by the procedure in such a way that the representation D is divided into the sub-regions T1-T5 in such a way that the marking durations of the laser marking apparatuses 20 for laser marking the corresponding sub-region T1-T5 are substantially equal. In other words, each laser marking apparatus 20 requires approximately the same marking duration to laser mark the corresponding sub-region T1-T5.

As also already mentioned, the objects 12 can be conveyed by the object conveyor 14 during laser marking. Preferably, the procedure can divide the representation D into the sub-regions T1-T5 depending on a conveying speed of the object conveyor 14 and/or on an (e.g., fixed) object distance (division) of adjacent objects 12 conveyed by the object conveyor 14.

It is also preferred that the procedure estimates (e.g., calculates) a total marking duration of the representation D depending on a maximum marking speed of the laser marking apparatuses 20, and optionally a maximum jump speed of the laser marking apparatuses 20. The estimated total marking duration can then be divided, for example, by a number of laser marking apparatuses 20 to calculate an individual marking duration. The sub-regions T1-T5 can then be formed, for example, depending on the calculated individual marking duration, preferably in such a way that each sub-region T1-T5 can be laser marked by a laser marking apparatus 20 in approximately the calculated individual marking duration.

It is also possible for the procedure to calculate a required number of the plurality of laser marking apparatuses 20 for laser marking the entire representation D and to output this to a user, for example via a user interface of the system 10. For example, the required number can be calculated depending on the representation D itself to be laser marked and other parameters, such as a maximum marking speed of the laser marking apparatuses 20, a maximum jump speed of the laser marking apparatuses 20, an object conveying speed of the object conveyor 14 and/or an individual marking duration for the laser marking apparatuses 20.

It is even possible to configure the procedure as an AI (artificial intelligence) procedure.

For example, the AI procedure can be trained by inputting representations D and corresponding manually or automatically divided sub-regions T1-T5 in order to learn how a representation D can be optimally divided into a plurality of sub-regions T1-T5.

It is also conceivable that the AI procedure is trained by inputting the representation D, the divided sub-regions T1-T5 and a result of the laser marking of the representation D on the object 12, which is detected by the sensor apparatus 30 (see FIG. 1). For example, the AI procedure can learn how to form sub-regions T1-T5 that are tolerant when there are positioning inaccuracies of the laser marking apparatuses 20.

Finally, in a step S14, the sub-regions T1-T5 are laser-marked on the object 12 by the plurality of laser marking apparatuses 20, so that ultimately the desired laser marking in accordance with the representation D is again produced on the object 12. The multiple laser marking apparatuses 20 each laser mark only one of the multiple sub-regions T1-T5 on the object 12. For example, a first laser marking apparatus 20 can mark a first sub-region T1 on the object 12, a second laser marking apparatus 20 can mark a second sub-region T2 on the object 12, etc.

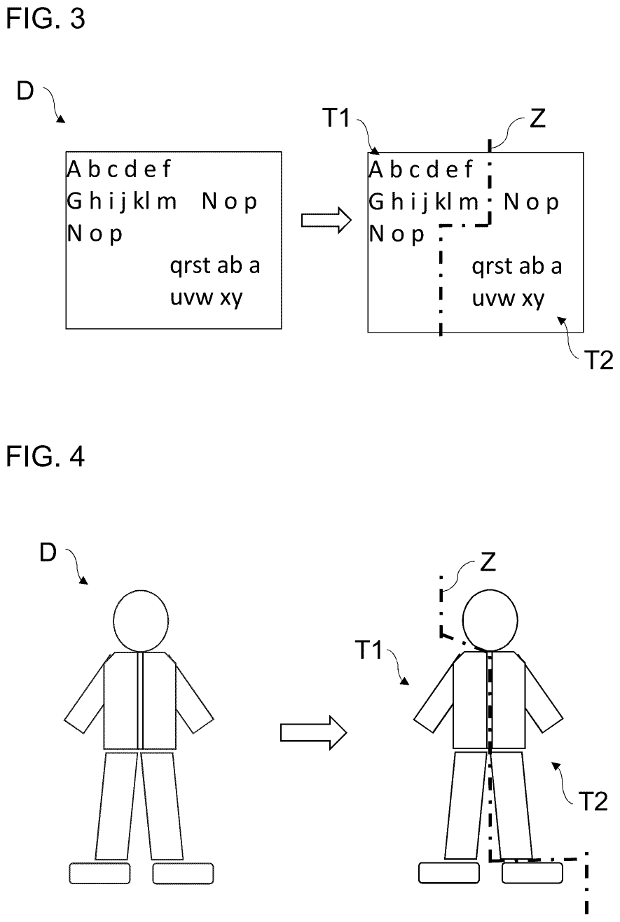

FIG. 3 to 9 illustrate exemplary variants of the procedure and preferred criteria of the procedure.

FIG. 3 shows by way of example that a representation D of characters, e.g., text characters, can be divided into two sub-regions T1 and T2 for two laser marking apparatuses 20.

The procedure can detect the elongated/linear separation zone Z, for example, by applying the syntax separation criterion and/or the syntax connection criterion. The separation zone Z formed as a dividing line between the two sub-regions T1 and T2 can have a plurality of line portions that are at an angle to one another and are preferably straight. The two sub-regions T1 and T2 can advantageously be formed in such a way that they require an approximately equal marking duration due to a substantially equal number of characters and similar distances from one another.

FIG. 4 shows by way of example that a pictorial representation D can be divided into two sub-regions T1, T2 for two laser marking apparatuses 20.

The separation zone Z can detect the procedure, for example, by applying the empty zone separation criterion, the fill zone connection criterion, the density separation criterion and/or the density connection criterion. The separation zone Z formed as a dividing line between the two sub-regions T1 and T2 can in turn have a plurality of line portions that are at an angle to one another and are preferably straight. The two sub-regions T1 and T2 can advantageously be formed in such a way that they require approximately equal marking duration due to a substantially equal number of representation elements.

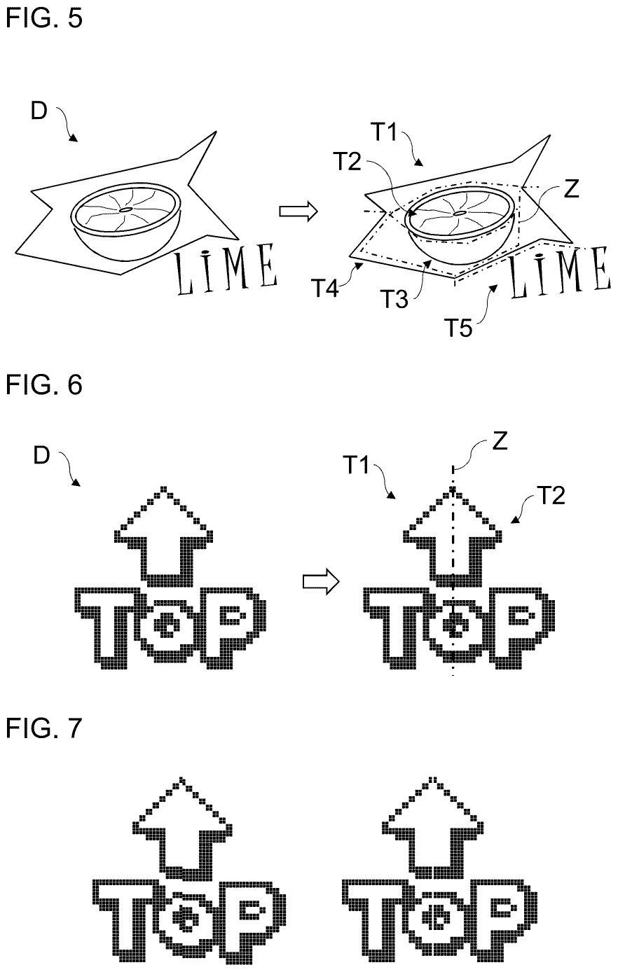

FIG. 5 shows by way of example that a pictorial representation D can be divided into five sub-regions T1-T5 for five laser marking apparatuses 20.

The procedure can detect the preferably linear separation zones Z using different criteria. For example, the separation zone Z between the sub-regions T1 and T4 can be detected using the discontinuity separation criterion and/or the continuity connection criterion. For example, the separation zones Z between the sub-regions T1 and T2, T2 and T3, T3 and T4 and T4 and T5 can be detected using the empty zone separation criterion and/or the fill zone connection criterion.

As can be deduced from the previous explanations, in vector graphics, such as the representation D in FIGS. 4 and 5, the sub-regions T1-T5 are preferably formed by the procedure in such a way that the sub-regions T1-T5 each extend only over a part of the vector graphic and are each substantially formed by representation elements contiguous with one another of the vector graphic.

In principle, this procedure can also be used for a representation D realized as a raster graphic, as shown by way of example in FIG. 6. Here, the procedure can divide the representation D into two sub-regions T1 and T2 using the criteria mentioned, e.g., as shown or in another way. However, in particular in the case of the shown division into the sub-regions T1 and T2, positioning inaccuracies of the laser marking apparatuses 20 could result in a visually unattractive overall impression, as is shown for two different examples (offset in the y-direction and offset in the x-direction) in FIG. 7 by way of example.

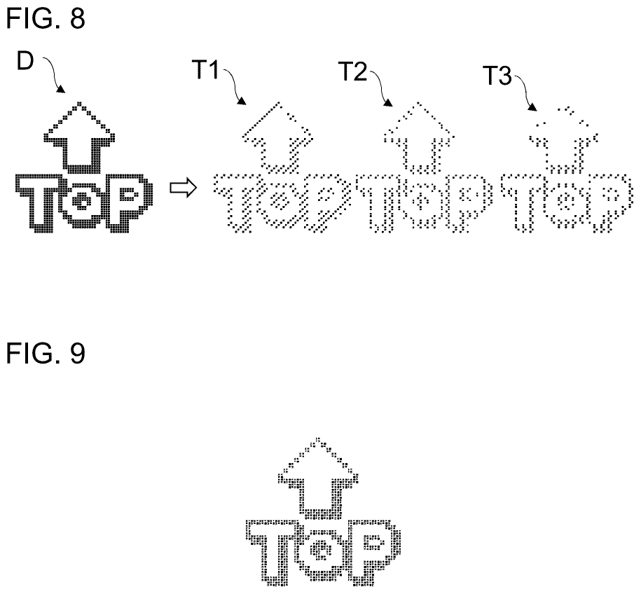

As shown in FIG. 8, it can therefore be preferred if the procedure divides a representation D executed as a raster graphic into sub-regions T1-T3 in such a way that the sub-regions T1-T3 are each formed by a plurality of representation points of the raster graphic. The representation points of the sub-regions T1-T3 can each be distributed over the entire raster graphic and can differ from the plurality of representation points of the other sub-regions. Preferably, an (imaginary) superimposition of the plurality of sub-regions T1-T3 can then again result in the raster graphic, or the representation D.

As shown in FIG. 9, a representation laser-marked in this way can be less sensitive or more tolerant to positioning inaccuracies of the laser marking apparatuses 20 while still conveying a visually appealing overall impression.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of the independent claims are each disclosed independently of one another. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 system
12 object
14 object conveyor
16 infeed conveyor
18 outfeed conveyor
20 laser marking apparatus
22 laser source
24 marking head
26 focusing optics
28 control device
30 sensor apparatus
32 processing device
S laser beam
S10-S14 method steps
T1-T5 sub-region
Z separation zone

1. A method for laser marking of objects, the method comprising:
providing a representation of a desired laser marking;
applying a computer-assisted procedure to the representation which divides the representation into a plurality of sub-regions; and
laser marking the plurality of sub-regions on an object by a plurality of laser marking apparatuses to generate the representation on the object, wherein the plurality of laser marking apparatuses each laser mark one of the plurality of sub-regions on the object.

2. The method according to claim 1, wherein at least one of the following conditions is met:
the plurality of sub-regions do not overlap one another;
the plurality of sub-regions are adjacent to one another;
the plurality of sub-regions together form the representation;
the plurality of sub-regions have substantially the same number of characters;
the plurality of sub-regions have substantially the same processing time; and
a dividing line between the plurality of sub-regions has a plurality of line portions that are at an angle to one another.

3. The method according to claim 1, wherein at least one of the following conditions is met:
the plurality of sub-regions are formed to reduce representation elements that cross sub-regions; and
the plurality of sub-regions are formed for optically reducing tolerance-related positioning inaccuracies at transitions between the plurality of sub-regions during laser marking of the plurality of sub-regions.

4. The method according to claim 1, wherein the applying of the computer-assisted procedure comprises:
detecting one or more potential separation zones in the representation that meet at least one predetermined separation criterion of the procedure,
wherein:
the procedure divides the representation into the plurality of sub-regions depending on the at least one detected potential separation zone.

5. The method according claim 4, wherein the at least one predetermined separation criterion comprises at least one of:
an empty zone separation criterion which is met when there is a zone of the representation that is free of representation elements;
a discontinuity separation criterion that is met when there is a discontinuous line transition in the representation;
a density separation criterion that is met if a zone of the representation has a lower point density and/or a lower line density relative to other zones of the representation and/or has an absolute point density and/or absolute line density which is smaller than a predetermined limit value;
a syntax separation criterion that is met when there is a space between strings of contiguous characters;
a character number separation criterion that is met between regions of the representation each having a substantially equal number of characters; and
a processing time synchronization separation criterion that is met between regions of the representation each having a substantially equal processing time.

6. The method according to claim 1, wherein the application of the procedure comprises:
detecting one or more connection zones in the representation that meet at least one predetermined connection criterion of the procedure,
wherein:
the procedure divides the representation into the plurality of sub-regions depending on the at least one detected connection zone.

7. The method according to claim 6, wherein the at least one predetermined connection criterion further comprises at least one of:
a fill zone connection criterion that is met when there is a zone of the representation that is filled with representation elements;
a continuity connection criterion which is met if there is a continuous line transition in the representation;
a density connection criterion which is met if a zone of the representation has a higher point density and/or a higher line density relative to other zones of the representation and/or has an absolute point density and/or an absolute line density which is greater than a predetermined limit value;
a syntax connection criterion that is met when there is a string of contiguous characters;
a code connection criterion which is met when there is a visual code made up of contiguous code elements; and
a processing time connection criterion that is met if a division into sub-regions is unnecessary due to a total processing time that is below a limit value.

8. The method according to claim 1, wherein at least one of the following conditions is met:
the procedure divides the representation into the plurality of sub-regions depending on a predetermined maximum marking speed of the plurality of laser marking apparatuses and/or a predetermined maximum jump speed of the plurality of laser marking apparatuses; and
the procedure divides the representation into the plurality of sub-regions such that marking durations of the plurality of laser marking apparatuses for laser marking the corresponding sub-region are substantially equal.

9. The method according to claim 1, wherein the method further comprises conveying of the object by an object conveyor during the laser marking.

10. The method according to claim 1, wherein:
the procedure estimates a total marking duration of the representation depending on a maximum marking speed of the plurality of laser marking apparatuses and optionally a maximum jump speed of the plurality of laser marking apparatuses and/or a conveying speed of an object conveyor and/or a target output power of the plurality of laser marking apparatuses;
divides the estimated total marking duration by a number of the plurality of laser marking apparatuses to calculate an individual marking duration; and
the plurality of sub-regions are formed depending on the calculated individual marking duration.

11. The method according to claim 1, wherein:
the procedure calculates and outputs a required number of the plurality of laser marking apparatuses for laser marking the plurality of sub-regions depending on the representation and a maximum marking speed of the plurality of laser marking apparatuses and optionally an object conveying speed of an object conveyor and/or an individual marking duration for the plurality of laser marking apparatuses.

12. The method according to claim 1, wherein:
the representation is a raster graphic; and
the procedure divides the raster graphic into the plurality of sub-regions in such a way that the plurality of sub-regions are each formed by a plurality of representation points of the raster graphic, which are distributed over the entire raster graphic and differ from the plurality of representation points of the other sub-regions.

13. The method according to claim 1, wherein:
the representation is a vector graphic or raster graphic; and
the procedure divides the vector graphic or raster graphic into the plurality of sub-regions in such a way that the plurality of sub-regions each extend only over a part of the vector graphic or raster graphic and/or are each substantially formed by representation elements contiguous with one another of the vector graphic or raster graphic.

14. The method according to claim 1, wherein the procedure is an AI procedure, and at least one of the following conditions is met:
the AI procedure is trained by inputting representations and associated divided sub-regions; and
the AI procedure is trained by inputting a representation, the associated divided sub-regions and a result of the laser marking of the plurality of sub-regions on the object detected by an optionally camera-supported sensor apparatus.

15. The method according to claim 1, wherein the objects are containers and the computer-assisted procedure is an algorithm.

16. The method according to claim 4, wherein the procedure divides the representation into the plurality of sub-regions depending on the at least one detected potential separation zone in such a way that the representation is divided at at least one of the detected potential separation zones.

17. The method according to claim 16, wherein the at least one predetermined separation criterion comprises a discontinuity separation criterion that is met when there is a discontinuous, angled, line transition in the representation.

18. The method according to claim 1, wherein at least one of the following conditions is met:
a dividing line between the plurality of sub-regions has a plurality of line portions that are at an angle to one another and are straight;
the application of the procedure comprises detecting one or more connection zones in the representation that meet at least one predetermined connection criterion of the procedure, wherein the procedure divides the representation into the plurality of sub-regions depending on the at least one detected connection zone, in such a way that the representation is not divided in at least one of the detected connection zones;
the method further comprises conveying of the object by an object conveyor during the laser marking, wherein the procedure divides the representation into a plurality of sub-regions depending on at least one of: (a) a predetermined or predeterminable, conveying speed of the object conveyor; (b) an object distance between adjacent objects conveyed by the object conveyor; and (c) an overall movement profile of the objects during conveying;
the representation is a raster graphic and the procedure divides the raster graphic into the plurality of sub-regions in such a way that the plurality of sub-regions are each formed by a plurality of representation points of the raster graphic, which are distributed over the entire raster graphic and differ from the plurality of representation points of the other sub-regions, wherein a superimposition of the plurality of sub-regions results in the raster graphic; and
the representation is a vector graphic or raster graphic and the procedure divides the vector graphic or raster graphic into the plurality of sub-regions in such a way that the plurality of sub-regions each extend only over a part of the vector graphic or raster graphic and/or are each substantially formed by representation elements contiguous with one another of the vector graphic or raster graphic, wherein placing the plurality of sub-regions next to one another results in the vector graphic or raster graphic.

19. A system for laser marking of objects, the system comprising:
a processing device configured to apply a computer-assisted procedure to a provided representation, which divides the representation into a plurality of sub-regions; and
a plurality of laser marking apparatuses which are configured to receive the plurality of sub-regions divided by the processing device and to laser mark them on the object to generate the representation on the object, wherein the plurality of laser marking apparatuses each laser mark one of the plurality of sub-regions on the object.

20. The system according to claim 19, wherein the computer-assisted procedure is an algorithm, the plurality of laser marking apparatuses each laser mark one of the plurality of sub-regions on the object and receive it, and the system further comprises an object conveyor arranged to convey the objects along the plurality of laser marking apparatuses.
